(19) United States
(12) Patent Application Publication
(10) Pub. No.: US 2015/0313182 A1
(43) Pub. Date: Nov. 5, 2015

(54) Visibility Enhancing Pet Garment Device

(71) Applicant: Joe D. Overman, Las Vegas, NV (US)

(72) Inventor: Joe D. Overman, Las Vegas, NV (US)

(21) Appl. No.: 14/266,394

(22) Filed: Apr. 30, 2014

(51) Int. Cl. A01K 13/00; F21V 23/04; F21L 4/02; F21V 33/00

(52) U.S. Cl. CPC A01K 13/006; F21V 33/0008; F21V 23/0414; F21L 4/02; F21V 23/0407; F21Y 2101/02

(57) ABSTRACT

A visibility enhancing pet garment device enhances visibility of a pet in dark conditions. The device includes a panel having a pair of spaced apertures extending therethrough. The panel is positionable against a torso of an animal with each of the animal's front legs extending through a respective one of the apertures. Each of a pair of flaps is extends from a respective side of the panel. The flaps are engageable together forming a loop securing the panel on the torso of the animal. Each of a plurality of lights is coupled to the panel and exposed on an outer surface of the panel wherein the lights are visible when the panel is secured to the torso of the animal.

### BACKGROUND OF THE DISCLOSURE

### Field of the Disclosure

The disclosure relates to pet garment devices and more particularly pertains to a new pet garment device for enhancing visibility of a pet in dark conditions.

### SUMMARY OF THE DISCLOSURE

An embodiment of the disclosure meets the needs presented above by generally comprising a panel having a pair of spaced apertures extending therethrough. The panel is positionable against a torso of an animal with each of the animal's front legs extending through a respective one of the apertures. Each of a pair of flaps is extends from a respective side of the panel. The flaps are engageable together forming a loop securing the panel on the torso of the animal. Each of a plurality of lights is coupled to the panel and exposed on an outer surface of the panel wherein the lights are visible when the panel is secured to the torso of the animal.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top back side perspective view of a visibility enhancing pet garment device according to an embodiment of the disclosure.

FIG. 2 is a bottom view of an embodiment of the disclosure.

FIG. 3 is a top view of an embodiment of the disclosure.

FIG. 4 is a side view of an embodiment of the disclosure in use.

FIG. 5 is a front view of an embodiment of the disclosure in use.

### DESCRIPTION OF THE PREFERRED EMBODIMENT

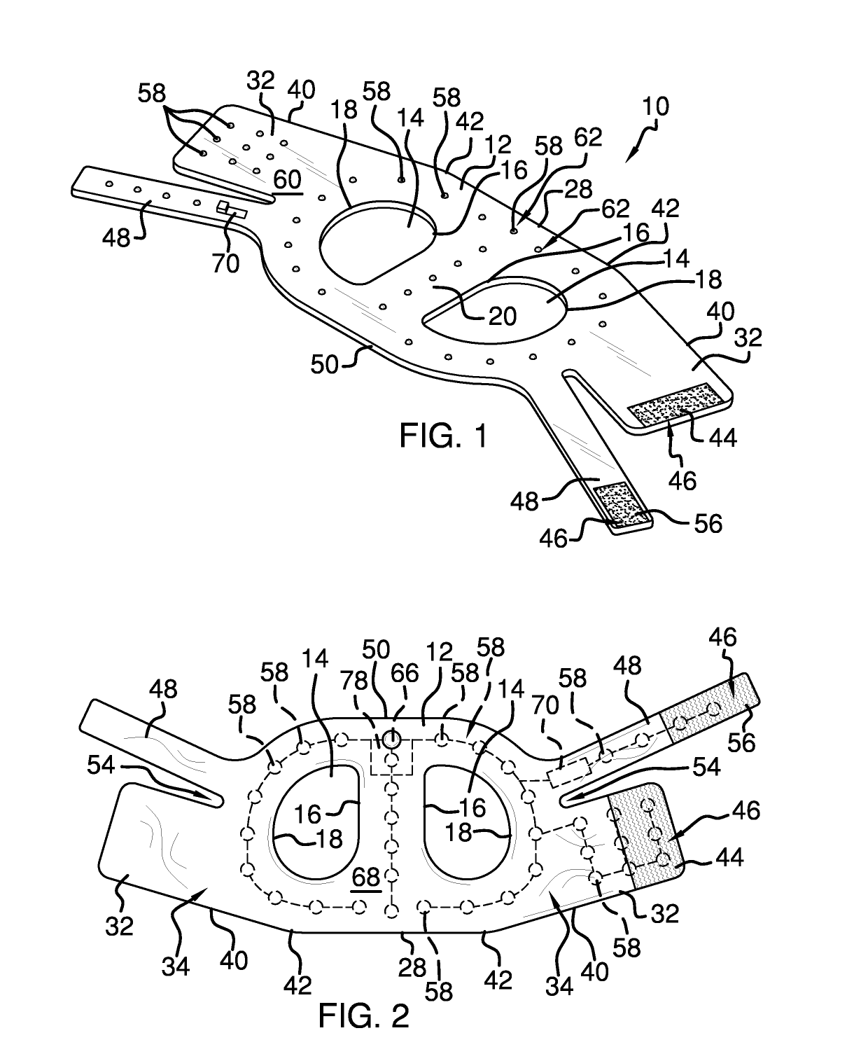

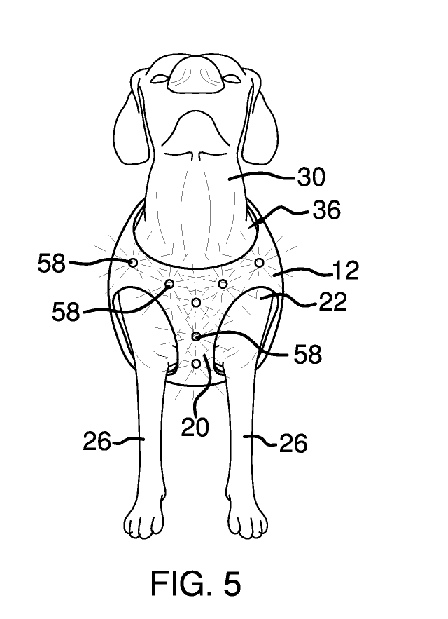

With reference now to the drawings, and in particular to FIGS. 1 through 5 thereof, a new pet garment device embodying the principles and concepts of an embodiment of the disclosure and generally designated by the reference numeral 10 will be described.

As best illustrated in FIGS. 1 through 5, the visibility enhancing pet garment device 10 generally comprises a panel 12 having a pair of spaced apertures 14 extending therethrough. Each aperture 14 may have a straight section 16 and a curved section 18. The straight sections 16 of the apertures 14 may be substantially aligned and parallel. The straight sections 16 may also be positioned adjacent to each other defining an interior strip 20 of the panel 12. The apertures 14 are arranged such that the panel 12 is positionable against a torso 22 of an animal 24 with each of the animal's front legs 26 extending through a respective one of the apertures 14 and the interior strip 20 extending between the front legs 26. The panel 12 has a front edge 28 which is positioned adjacent to a neck 30 of the animal 24 when the panel 12 is positioned on the animal 24. Each of a pair of flaps 32 is coupled to and extends from the panel 12. Each of the flaps 32 extends from a respective side 34 of the panel 12. The flaps 32 are engageable together forming a loop 36 wherein the flaps 32 are configured for securing the panel 12 on the torso 22 of the animal 24. Each of the flaps 32 has a respective forward edge 40 extending from a respective end 42 of the front edge 28 of the panel 12. Each forward edge 40 extends outwardly and rearwardly from the respective end 42 of the front edge 28 of the panel 12. Each of a pair of flap fasteners 44 is coupled to an associated one of the flaps 32. The flap fasteners 44 are complementary portions of hook and loop fastener 46.

Each of a pair of straps 48 is coupled to and extends from the panel 12. Each of the straps 48 extends from a respective one of the sides 34 of the panel 12. Each of the straps 48 is positioned between a rear edge 50 of the panel 12 and an associated one of the flaps 32. The straps 48 are engageable together forming a second loop 52 wherein the straps 48 are configured for securing the rear edge 50 of the panel 12 against the torso 22 of the animal 24. Each of the straps 48 extends outwardly and rearwardly from the panel 12 defining a respective acute angle 54 between the each strap 48 and an adjacently positioned one of the flaps 32. Each of a pair of strap fasteners 56 is coupled to an associated one of the straps 48. The strap fasteners 56 may also be complementary portions of hook and loop fastener 46.

A plurality of lights 58 is coupled to the panel 12. The lights 58 may be embedded into the panel 12 but exposed on an outer surface 60 of the panel 12 wherein the lights 58 are visible when the panel 12 is secured to the torso 22 of the animal 24. Each of the lights 58 may be a light emitting diode 62. The lights 58 are electrically connected in a single string 64. The lights 58 extend into one of the flaps 32 and one of the straps 48. The lights 58 may extend into only one of the flaps 32 and one of the straps 48, more particularly the one of the flaps 32 and the straps 48 that overlap and are positioned exteriorly relative to the other flap 32 and strap 48. Thus, the lights 58 are exposed and visible when the panel 12 is coupled to the animal 24 and there are no covered lights 58 when the loop 36 and second loop 52 are formed.

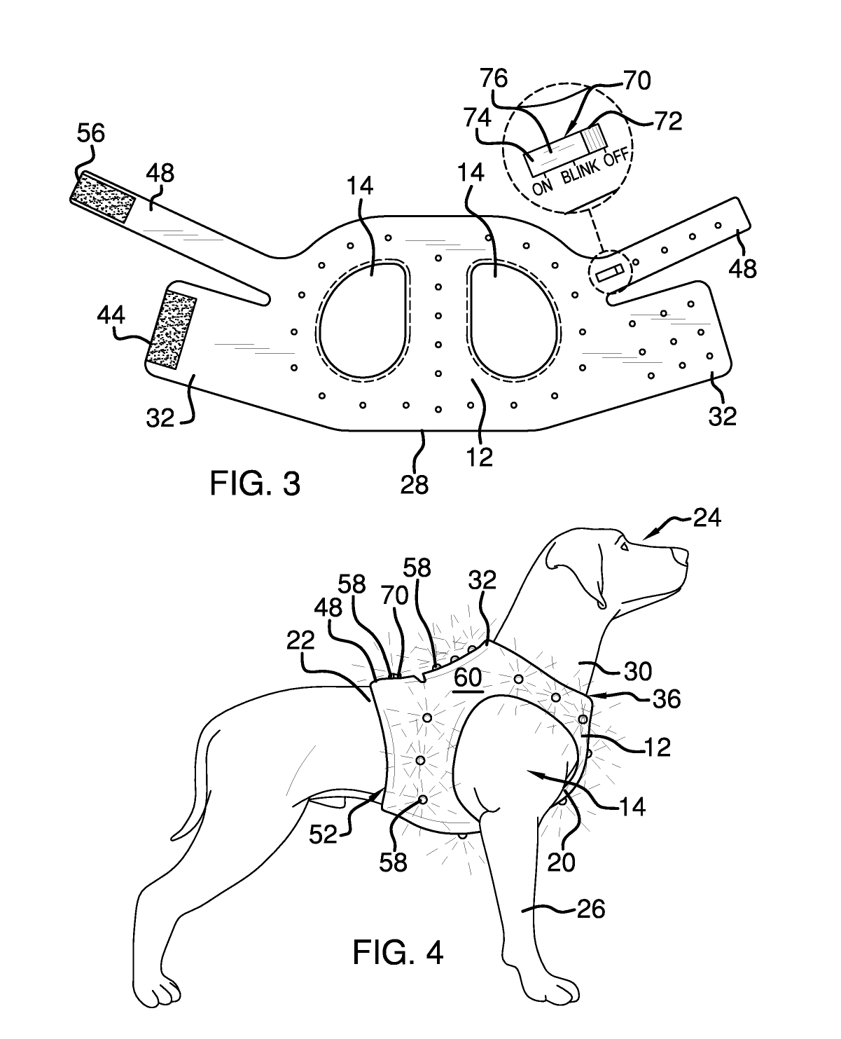

A battery 66 is coupled to the panel 12 and may be embedded between an inner surface 68 and the outer surface 60 of the panel 12. The battery 66 is electrically coupled to the lights 58. A switch 70 is electrically coupled between the lights 58 and the battery 66 wherein the lights 58 are selectively actuated by manipulation of the switch 70. The switch 70 may be a sliding switch as shown in FIG. 3. The switch 70 includes an off position 72, an on position 74, and a blink position 76. The lights 58 are off when the switch 70 is in the off position 72, the lights 58 are illuminated when the switch 70 is in the on position 74, and the lights 58 are periodically illuminated when the switch 70 is positioned in the blink position 76. The lights 58 may be provided in various configurations extending around and between the apertures 14. Each of the lights 58 may be a single color and all of the lights 58 may be the same single color. Using conventional mechanisms which may be incorporated into the switch 70, battery 66 and with the possible addition of a processor 78, the lights 58 may be a selectable single color or the lights 58 may cycle through a plurality of colors or a pattern of blinking.

In use, the panel 12 is secured on the animal 24 as described above. The lights 58 are illuminated as desired to enhance visibility of the animal 24 while the panel 12 is worn.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure.

I claim:

1. A visibility enhancing pet garment device comprising:
a panel having a pair of spaced apertures extending therethrough, said apertures being arranged wherein said panel is positionable against a torso of an animal with each of the animal's front legs extending through a respective one of said apertures;
a pair of flaps coupled to and extending from said panel, each of said flaps extending from a respective side of said panel, said flaps being engageable together forming a loop wherein said flaps are configured for securing said panel on the torso of the animal; and
a plurality of lights coupled to said panel, each of said lights being exposed on an outer surface of said panel wherein said lights are visible when said panel is secured to the torso of the animal.

2. The device of claim 1, further comprising:
said panel having a front edge; and
each of said flaps having a forward edge extending from a respective end of said front edge of said panel, each said forward edge extending outwardly and rearwardly from said respective end of said front edge of said panel.

3. The device of claim 1, further comprising a pair of straps coupled to and extending from said panel, each of said straps extending from a respective said side of said panel, each of said straps being positioned between a rear edge of said panel and an associated one of said flaps, said straps being engageable together forming a second loop wherein said straps are configured for securing said rear edge of said panel against the torso of the animal.

4. The device of claim 3, further comprising each of said straps extending outwardly and rearwardly from said panel defining a respective acute angle between said each said strap and an adjacently positioned one of said flaps.

5. The device of claim 1, further comprising a battery coupled to said panel, said battery being electrically coupled to said lights.

6. The device of claim 1, further comprising each of said lights being a light emitting diode.

7. The device of claim 6, further comprising said lights being electrically connected in a single string.

8. The device of claim 1, further comprising said lights extending into one of said flaps.

9. The device of claim 3, further comprising said lights extending into one of said straps.

10. The device of claim 1, further comprising a pair of flap fasteners, each of said flap fasteners being coupled to an associated one of said flaps, said flap fasteners being complementary portions of hook and loop fastener.

11. The device of claim 3, further comprising a pair of strap fasteners, each of said strap fasteners being coupled to an associated one of said straps, said strap fasteners being complementary portions of hook and loop fastener.

12. The device of claim 5, further comprising a switch electrically coupled between said lights and said battery wherein said lights are selectively actuated by manipulation of said switch.

13. The device of claim 12, further comprising said switch being a sliding switch.

14. The device of claim 12, further comprising said switch including an off position, an on position, and a blink position, said lights being off when said switch is in said off position, said lights being illuminated when said switch is in said on position, and said lights being periodically illuminated when said switch is positioned in said blink position.

15. The device of claim 6, further comprising each of said lights being a single color.

16. The device of claim 6, further comprising all of said lights being the same single color.

17. The device of claim 6, further comprising said lights being a selectable single color.

18. The device of claim 6, further comprising said lights cycling through a plurality of colors.

19. A visibility enhancing pet garment device comprising:
a panel having a pair of spaced apertures extending therethrough, said apertures being arranged wherein said panel is positionable against a torso of an animal with each of the animal's front legs extending through a respective one of said apertures, said panel having a front edge;
a pair of flaps coupled to and extending from said panel, each of said flaps extending from a respective side of said panel, said flaps being engageable together forming a loop wherein said flaps are configured for securing said panel on the torso of the animal, each of said flaps having a forward edge extending from a respective end of said front edge of said panel, each said forward edge extending outwardly and rearwardly from said respective end of said front edge of said panel;
a pair of flap fasteners, each of said flap fasteners being coupled to an associated one of said flaps, said flap fasteners being complementary portions of hook and loop fastener;
a pair of straps coupled to and extending from said panel, each of said straps extending from a respective said side of said panel, each of said straps being positioned between a rear edge of said panel and an associated one of said flaps, said straps being engageable together forming a second loop wherein said straps are configured for securing said rear edge of said panel against the torso of the animal, each of said straps extending outwardly and rearwardly from said panel defining a respective acute angle between said each said strap and an adjacently positioned one of said flaps;
a pair of strap fasteners, each of said strap fasteners being coupled to an associated one of said straps, said strap fasteners being complementary portions of hook and loop fastener;
a plurality of lights coupled to said panel, each of said lights being exposed on an outer surface of said panel wherein said lights are visible when said panel is secured to the torso of the animal, each of said lights being a light emitting diode, said lights being electrically connected in a single string, said lights extending into one of said flaps, said lights extending into one of said straps;
a battery coupled to said panel, said battery being electrically coupled to said lights; and
a switch electrically coupled between said lights and said battery wherein said lights are selectively actuated by manipulation of said switch, said switch being a sliding switch, said switch including an off position, an on position, and a blink position, said lights being off when said switch is in said off position, said lights being illuminated when said switch is in said on position, and said lights being periodically illuminated when said switch is positioned in said blink position.
